(19) United States
(12) Patent Application Publication
(10) Pub. No.: US 2013/0126040 A1
(43) Pub. Date: May 23, 2013

(54) METHOD AND INSTALLATION FOR FILLING CONTAINERS WITH LIQUID CONTENTS

(71) Applicant: Ludwig Clüsserath, Bad Kreuznach (DE)

(72) Inventor: Ludwig Clüsserath, Bad Kreuznach (DE)

(73) Assignee: KHS GMBH, Dortmund (DE)

(21) Appl. No.: 13/813,670

(22) PCT Filed: May 6, 2011
(86) PCT No.: PCT/EP2011/002272

§ 371 Date: Feb. 1, 2013

(30) Foreign Application Priority Data
Aug. 3, 2010 (DE) 10 2010 033 169.4

(51) Int. Cl. B67C 3/16

(52) U.S. Cl. CPC B67C 3/16
USPC 141/65; 141/8

(57) ABSTRACT

A method for filling containers with liquid content using a filling machine includes partially evacuating a container before filling it, and pre-heating said liquid content to a filling temperature by using a negative pressure supplied from a pump operated with a sealing liquid to discharge, into said liquid content, thermal energy accrued from cooling of said sealing liquid.

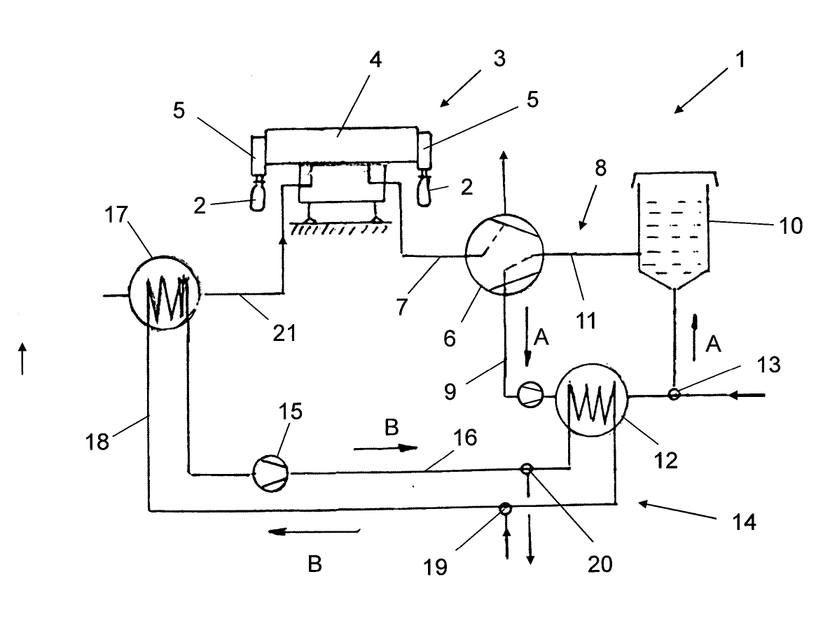

The invention relates to a method according to the preamble of patent claim 1 as well as to an installation according to the preamble of patent claim 6.

It is customary and known, in particular when filling oxygen-sensitive products, i.e. products whose quality and/or shelf life are adversely affected by oxygen, for example when filling beer into bottles or similar containers, to evacuate the particular container interior before the actual filling, i.e. before the introduction of the product or contents, and then to rinse and/or to pre-stress it with inert gas (CO2 gas). The vacuum that is required for evacuating is supplied for example by at least one vacuum pump configured as a liquid pump or liquid-ring vacuum pump which for sealing off the transition between a rotating vane-type pump rotor and the interior surface of a pump housing is operated with the use of a sealing liquid, as a rule with the use of sealing water, in which case, given the high delivery rates of such pumps for example in the range between 10 KW and 30 KW, a significant heating-up of the sealing liquid occurs as a result of friction alone. A heating-up of the sealing liquid is particularly disadvantageous because the efficiency of such an installation falls as the temperature of the sealing liquid rises.

For cooling, including cooling the respective vacuum pump, it is therefore necessary either to cool the sealing liquid that is carried in a continuous cooling circuit or to continuously replace the sealing water by fresh water having a lower temperature. In conventional installations for the filling of bottles or other containers this means a considerable consumption of fresh water (up to 3 m³/h) with associated substantial operating costs, or alternatively it is necessary to discharge the heat energy which accrues when cooling the sealing liquid to the environment, involving a burden on the environment as well as additional operating costs for cooling blowers etc.

Methods are also known for reducing the energy consumption in container treatment machines, in particular for improving the heat balance in a pasteurisation installation for the pasteurising of drinks DE 103 51 689 A1) in which the waste heat contained in the process liquid of a pasteurisation installation is used to preheat the product which is fed to the filling machine.

Other methods and installations for filling containers (DE 10 2007 006 519 A1) are known in which the containers are treated in a cleaning and/or washing machine, for example in a rinser, before they are filled and then after they are filled and sealed are heated up and then cooled down again in a pasteurisation installation. To reduce the energy demand and/or the operating costs of the installation, the waste water accruing at an outlet of the cleaning and washing machine is fed to the pasteurisation installation in order to make use of the inner energy of this waste water or the waste water itself.

The object of the invention is to provide a method in which, before they are filled, the containers are subjected to the negative pressure or vacuum supplied by at least one liquid pump or liquid-ring vacuum pump, and with which an operating cost-reducing cooling of the sealing liquid of the at least one liquid pump or liquid-ring vacuum pump is achieved. A method according to claim 1 is configured to resolve this object. An installation for filling containers is the subject-matter of claim 6.

In the inventive method, a liquid pump or liquid-ring vacuum pump is used to generate the vacuum that is necessary for vacuum treatment or for the pre-evacuating. According to the invention, the sealing liquid used in these vacuum pumps—said sealing liquid being as a rule sealing water—is cooled by the contents or product/by the cooling load of the contents or product, which according to the knowledge underlying the invention is particularly suitable for cooling the sealing liquid and is fed to the filling machine according to the prior art at a relatively low storage temperature, for example at a storage temperature ranging from 0° C. to 4° C.

The sealing liquid of the at least one liquid pump or liquid-ring vacuum pump is carried in a continuous cooling circuit which contains at least one heat exchanger through whose primary side the sealing liquid flows and by which the cooling of the sealing liquid is effected. The contents for example then flow through the secondary side of this heat exchanger. Preferably however the secondary side of the heat exchanger is part of a cooling and/or preheating circuit through which flows a liquid heat-transporting medium, preferably water, and in which is disposed the primary side of at least one further heat exchanger which serves as a preheater for a preheating of the contents to a higher filling temperature and through whose secondary side the contents flow for this purpose.

Preheating the contents from storage temperature to the higher filling temperature prevents the formation of condensation water on the outer surface of the filled containers and on the outer surface of the container caps as well as related disadvantages such as for example a detaching of the labels and/or corroding of container caps made from metal etc., in particular also during unfavourable temperature and/or weather conditions.

The use of the additional cooling and/or preheating circuit has the additional advantage that additional energy for preheating the contents can be introduced into this cooling and/or preheating circuit if the thermal energy drawn from the sealing liquid during cooling is insufficient for a complete preheating of the contents to a filling temperature that reliably prevents condensation water formation. The thermal energy additionally fed to the additional cooling and/or preheating circuit is preferably the waste heat from at least one of the other components of the installation, for example the waste heat from a pasteurisation installation and/or a cleaning and/or rinsing machine.

For the purpose of the invention the expression “essentially” means variations from the respective exact value by +/−10%, preferably by +/−5% and/or variations in form of changes insignificant for the function.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

The invention is explained in detail below by reference to the FIGURE which in a functional representation depicts an installation 1 for the filling of contents, e.g. a drink, for example for the filling of beer into containers in the form of bottles 2.

A central element of installation 1 is a filling machine 3 which exhibits the configuration known to the skilled person and which in the depicted embodiment is provided on a rotor 4 which can be driven to rotate about a vertical machine axis and which has a plurality of filling points 5 for filling bottles 2 with the contents and for pretreating the bottle interior of each bottle 2 before initiating the actual filling process. This pretreatment of bottles 2 takes place in installation 1 among other things by evacuating (pre-evacuating) the bottle interior to avoid a product-harming oxygen level present in the contents or in the filled and capped bottles 2.

To generate the vacuum that is needed for the evacuating of bottles 2 there is provided in installation 1 at least one vacuum pump configured as a liquid-ring vacuum pump 6 whose vacuum connection is connected by a line 7 to filling machine 3 and whose exhaust air connection is open to atmosphere. With liquid-ring vacuum pump 6, whose working capacity lies for example in the range between 10 KW and 30 KW, is associated a continuous cooling circuit 8 for cooling the sealing water used as sealing liquid and consisting specifically of line 9, a buffer or storage tank 10 which is connected by line 9 to the sealing water outlet of liquid-ring vacuum pump 6, and of a line 11 which connects storage 10 to the sealing water inlet of liquid-ring vacuum pump 6. In at least one of lines 9 and 11 is provided a circulation pump which generates a sealing water flow from liquid-ring vacuum pump 6 through line 9 into storage tank 10 and out of storage tank 10 through line 11 back to liquid-ring vacuum pump 6, as indicated by arrow A.

A heat exchanger 12 for cooling the sealing water flowing through the primary side of this heat exchanger is disposed in line 9. A connection 13 through which fresh water can be fed to the sealing water circuit or cooling circuit 8 is also disposed in line 9 downstream of heat exchanger 12 in the direction of flow of the sealing water.

The secondary side of heat exchanger 12 through which the sealing water does not flow, i.e. which is separated from the sealing water circuit, is part of a further cooling and/or preheating circuit 14 which again uses water as heat-transporting medium and comprises among other things a circulation pump 15 in a line 16 and a further heat exchanger 17 whose primary side is connected by line 16 and a line 18 to the secondary side of heat exchanger 12. A circulating flow of water is generated in cooling and/or preheating circuit 14 with the help of circulation pump 15, passing as indicated by arrows B from pump 15 to heat exchanger 12, from the latter through line 18 to heat exchanger 17 and from the latter back to pump 15.

In line 18 is provided a connection 19 for the feeding of external water, for example hot water, whose thermal energy for example originates as waste heat from other components (not shown) of installation 1, e.g. from a cleaning and/or rinsing machine and/or from a device for pasteurising the contents, for example for pasteurising the contents already filled into bottles 2. A further connection 20 for discharging water out of cooling circuit 14 is provided in line 16 in the direction of flow between pump 15 and heat exchanger 17.

The secondary side of heat exchanger 17 separated from the heat-transporting medium or water of cooling and/or preheating circuit 14 is arranged in a product line 21 through which the contents (e.g. beer) are fed at a low storage temperature, for example at a storage temperature ranging from 0° C. to 4° C., to filling machine 3 from storage tanks (not shown) arranged in a storage cellar. The thermal energy which is introduced into the contents at heat exchanger 17 via cooling and/or preheating circuit 14 from cooling circuit 8 is for example sufficient to heat up the contents to a filling temperature that is considerably above the storage temperature, for example to a filling temperature in the range between approx. 10° C. and 14° C., at which the contents are then introduced into bottles 2 at filling stations 5 of filling machine 3.

The advantage of installation 1 consists among other things in that ultimately the contents/their cooling load is used to cool the sealing water and in the process the thermal energy accruing in heat exchanger 12 effects a preheating of the contents to the filling temperature that is higher than the storage temperature such that it is not necessary for the thermal energy which accrues when the sealing water is cooled to be released into the environment. Instead, a condensation water formation on the outer surface of filled bottles 2 and on the bottle caps as well as the attendant disadvantages, such as for example a detaching of labels through condensation, a corrosion of metal caps through condensation etc., are avoided through the preheating of the contents even in unfavourable temperature and/or weather conditions, for example when a high relative humidity is present in the area around the filling machine 3 and/or downstream units.

The inventive configuration avoids a cost-intensive cooling of the sealing water of the liquid-ring vacuum pump 6 for example through the feeding of fresh water or by way of a separate external cooling circuit with additional coolant consumption and/or energy expenditure.

The further cooling and/or preheating circuit 14 has the advantage that if the thermal energy withdrawn from the sealing water during cooling is not sufficient, for example when starting up installation 1, to heat the contents up to a filling temperature which reliably avoids a condensation water formation on the filled bottles and their bottle caps, heated water can be fed from the exterior into cooling circuit 14 through connection 19 and surplus water taken away from the cooling circuit through connection 20. The water fed through connection 19 is heated up preferably using the thermal energy or waste heat of a further component of installation 1, for example the waste heat of a pasteurisation installation and/or cleaning and/or rinsing machine.

The invention has been described hereinbefore by reference to one embodiment. It goes without saying that numerous variations as well as modifications are possible without departing from the inventive concept underlying the invention.

### LIST OF REFERENCE SIGNS

1 Installation
2 Bottle
3 Filling machine
4 Rotor
5 Filling position at rotor 4
6 Vacuum pump or liquid-ring vacuum pump
7 Line
8 Cooling circuit for vacuum pumps 6
9 Line
10 Storage and balancing tank
11 Line
12 Heat exchanger
13 Connection
14 Cooling and/or preheating circuit
15 Circulation pump
16 Line
17 Heat exchanger
18 Line
19,20 Connection
21 Product line

1-9. (canceled)

10. A method for filling a container with liquid content using a filling machine, said method comprising at least partially evacuating said container before filling said container, and pre-heating said liquid content to a filling temperature, wherein pre-heating comprises, using a negative pressure supplied from at least one pump operated with a sealing liquid, said at least one pump being selected from the group consisting of a liquid pump and a liquid-ring vacuum pump, discharging, into said liquid content, thermal energy accrued from cooling of said sealing liquid.

11. The method of claim 10, further comprising cooling said sealing liquid in a cooling circuit.

12. The method of claim 10, wherein preheating said liquid content comprises pre-heating up to a filling temperature that lies above a dew point of a volume surrounding said container, thereby suppressing condensation of water on at least one of an outer surface of said container and a cap of said container.

13. The method of claim 10, wherein preheating said liquid content comprises pre-heating up to a filling temperature in the range between 10° C. and 15° C.

14. The method of claim 10, wherein discharging, into said liquid content, thermal energy accrued from cooling of said sealing liquid comprises transmitting at least part of said thermal energy through at least one heat exchanger arrangement to said liquid content.

15. The method of claim 14, further comprising feeding at least some thermal energy to a further heat-exchange circuit when thermal energy taken from said sealing liquid as it cools is insufficient to heat said liquid content to a filling temperature that reliably prevents condensation of water on at least one of said container and a cap of said container.

16. The method of claim 14, further comprising feeding at least some thermal energy to a further heat-exchange circuit for providing additional thermal energy when thermal energy taken from said sealing liquid as it cools is insufficient to heat said liquid content to a filling temperature that reliably prevents condensation of water on at least one of said container and a cap of said container, said additional thermal energy being waste heat from a component of said filling machine.

17. The method of claim 10, wherein discharging, into said liquid content, thermal energy accrued from cooling of said sealing liquid comprises transmitting at least part of said thermal energy indirectly to said liquid content via a further heat-exchange circuit selected from the group consisting of a further cooling circuit and a further pre-heating circuit.

18. An apparatus for filling containers with liquid content, said apparatus comprising a filling machine comprising a plurality of filling points for receiving said containers, at least one vacuum pump, operated with a sealing liquid, configured for at least partially evacuating an interior of a container at a filling point, and means for cooling said sealing liquid by said liquid content.

19. The apparatus of claim 18, wherein said vacuum pump comprises a liquid pump.

20. The apparatus of claim 18, wherein said vacuum pump comprises a liquid-ring vacuum pump.

21. The apparatus of claim 18, further comprising a continuous cooling circuit for said sealing liquid, said continuous cooling circuit comprising a first heat exchanger for cooling said sealing liquid and for discharging, into said liquid content, thermal energy that accrues during cooling of said sealing liquid.

22. The apparatus of claim 21, further comprising a heat exchange circuit comprising a primary side of a second heat exchanger, which forms a preheater, and a secondary side of said second heat exchanger, through which liquid content fed to said filling machine flow, said heat exchange circuit being connected to said cooling circuit via said first heat exchanger.

23. The apparatus of claim 22, wherein a heat-transporting medium of said heat exchange circuit is water.

24. The apparatus of claim 22, further comprising means for controlled introduction of additional thermal energy into said heat exchange circuit.

25. The apparatus of claim 22, further comprising means for controlled introduction of additional thermal energy into said heat exchange circuit from waste heat from another component of said filling machine.

26. The apparatus of claim 22, further comprising means for controlled introduction of additional thermal energy into said heat exchange circuit from a pasteurization unit.

27. The apparatus of claim 22, further comprising means for controlled introduction of additional thermal energy into said heat exchange circuit from a cleaning machine.

28. The apparatus of claim 22, further comprising means for controlled introduction of additional thermal energy into said heat exchange circuit from a rinsing machine.
